(19) United States
(12) Patent Application Publication
(10) Pub. No.: US 2018/0086157 A1
(43) Pub. Date: Mar. 29, 2018

(54) PNEUMATIC TIRE

(71) Applicant: TOYO TIRE & RUBBER CO., LTD., Osaka (JP)

(72) Inventor: Keisuke Matsubara, Osaka-shi (JP)

(73) Assignee: TOYO TIRE & RUBBER CO., LTD., Osaka (JP)

(21) Appl. No.: 15/581,659

(22) Filed: Apr. 28, 2017

(30) Foreign Application Priority Data
Sep. 27, 2016 (JP) 2016-188122

(51) Int. Cl. B60C 13/02

(52) U.S. Cl. CPC B60C 13/02; B60C 2200/14

(57) ABSTRACT

A pneumatic tire has a pair of bead portions, side wall portions and a tread portion. An annular projections group in which a plurality of projections extending in the tire diametrical direction are arranged in a tire circumferential direction, is formed on an outer surface of a buttress region of the side wall portion. The annular projections groups at both sides are arranged to be shifted their positions in the tire circumferential direction in such a manner that a center position in the width of a projection in one side is faced to a gap between projections in the other side, and a center position in the width of a projection in the other side is faced to a gap between projections in the one side.

### BACKGROUND OF THE INVENTION

### Field of the Invention

The present invention relates to a pneumatic tire aiming at traveling on a punishing road such as a muddy terrain and a rocky stretch.

### Description of the Related Art

With regard to the pneumatic tire aiming at the traveling on the punishing road, there has been known a technique in which an annular projections group having a plurality of projections arranged in a tire circumferential direction is formed on an outer surface of a buttress region of a side wall portion. For example, Patent Documents 1 to 3 filed by the applicant of the present application should be referred. According to the configuration mentioned above, in a scene traveling on a muddy terrain and a sand pip, traction is generated by shear resistance of the projections and it is possible to improve a punishing road traveling property.

However, since the projections and the gaps between the projections are alternately arranged along the tire circumferential direction in the buttress region where the annular projections group is formed, unbalance is generated by a rubber volume, and unevenness in an inner periphery (a circumferential length of a tire inner surface) is caused. As a result, uniformity of the tire tends to be deteriorated.

Patent document 4 describes a pneumatic tire in which convex portions in a buttress region are arranged in both sides to be shifted each other in a tire circumferential direction. The convex portions are formed for the purpose of reducing a load noise by increasing weight of a portion which forms an antinode of vibration, and are extended along the tire circumferential direction. As a result, the convex portions are lack in an action for generating the traction on the basis of the shear resistance of the convex portions, and there is thought that an effect of improving the punishing road traveling property can not be sufficiently obtained.

### PRIOR ART DOCUMENT

### Patent Document

Patent Document 1: JP-A-2004-291936

Patent Document 2: JP-A-2010-264962

Patent Document 3: JP-A-2013-119277

Patent Document 4: JP-A-2001-130223

### SUMMARY OF THE INVENTION

The present invention is made by taking the above actual condition, and an object of the present invention is to provide a pneumatic tire which forms an annular projection group capable of improving a punishing road traveling property and can suppress deterioration of uniformity caused thereby.

The object can be achieved by the following present invention. The present invention provides a pneumatic tire comprising a pair of bead portions, side wall portions which extend outward in a tire diametrical direction from each of the bead portions and a tread portion which is connected to an outside end in the tire diametrical direction of each of the side wall portions, wherein an annular projections group in which a plurality of projections extending in the tire diametrical direction are arranged in a tire circumferential direction, is formed on an outer surface of a buttress region of the side wall portion, and wherein the annular projections groups at both sides are arranged to be shifted their positions in the tire circumferential direction in such a manner that a center position in the width of a projection in one side is faced to a gap between projections in the other side, and a center position in the width of a projection in the other side is faced to a gap between projections in the one side.

The annular projections group formed in the buttress region of the tire is constructed by a plurality of projections which extend in the tire diametrical direction. As a result, in a scene traveling on the punishing road such as the muddy terrain, a traction is generated by shear resistance of the projections and it is possible to improve a punishing road traveling property. Further, since the annular projections groups in both sides are arranged to be shifted their positions in the tire circumferential direction as mentioned above, unbalance due to a rubber volume is canceled and an inner periphery is uniformized. As a result, it is possible to suppress deterioration of uniformity.

It is preferable that the center position in the width of the projection faces to a center area of the gap between the projections in an opposite side thereof, and wherein the center area of the gap is a region in a range of 60% of the width of the gap around the center position in the width of the gap. According to the configuration mentioned above, the inner periphery is well uniformized and the effect of improving uniformity can be enhanced.

It is preferable that the annular projections group is constructed by plural kinds of projections having different volumes. According to the configuration mentioned above, there can be obtained an effect of improving a catching action in the rocky stretch on the basis of the annular projections group, and enhancing a design property by applying a stereoscopic effect to the buttress region.

It is preferable that a circumferential rib extending in the tire circumferential direction and connecting the projections each other is formed on the outer surface of the buttress region in the side wall portion. The rigidity of each of the projections is enhanced by the connection with the circumferential rib, and it is possible to improve the traction caused by the shear resistance of the projections.

### BRIEF DESCRIPTION OF THE DRAWINGS

FIG. 1 is a tire meridian cross sectional view schematically showing an example of a pneumatic tire according to the present invention;

FIG. 2 is a side elevational view showing apart of a buttress region of the tire as seen from a tire width direction;

FIG. 3 is a plan view of the tire and schematically shows the tire while omitting a tread pattern;

FIG. 4 is an enlarged view of a substantial part in FIG. 3;

FIG. 5 is a tire meridian half cross sectional view schematically showing a pneumatic tire according to the other embodiment;

FIG. 6 is a side elevational view showing a part of a buttress region of the tire in FIG. 5; and

FIG. 7 is an enlarged view of a substantial part in FIG. 5.

### DETAILED DESCRIPTION OF THE PREFERRED EMBODIMENTS

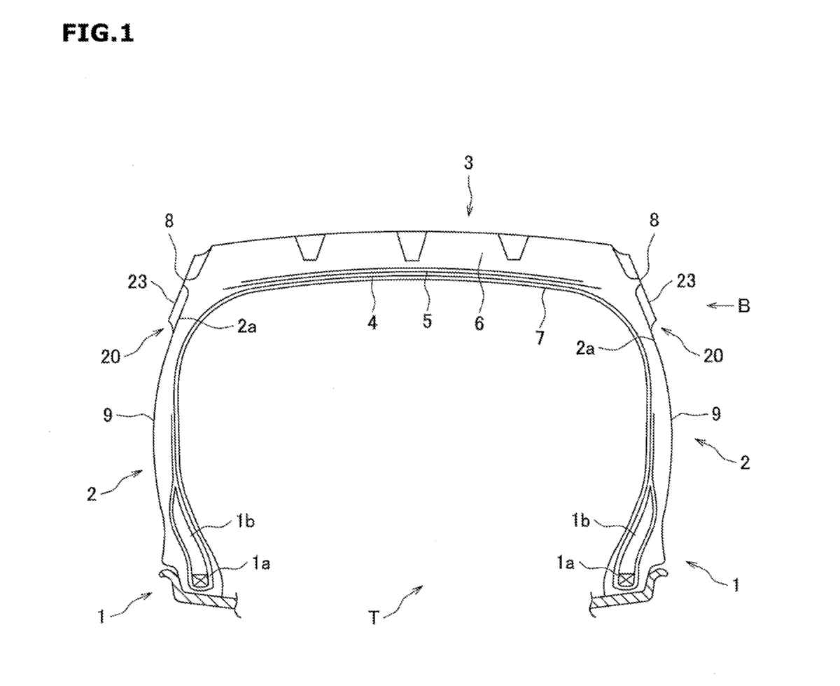

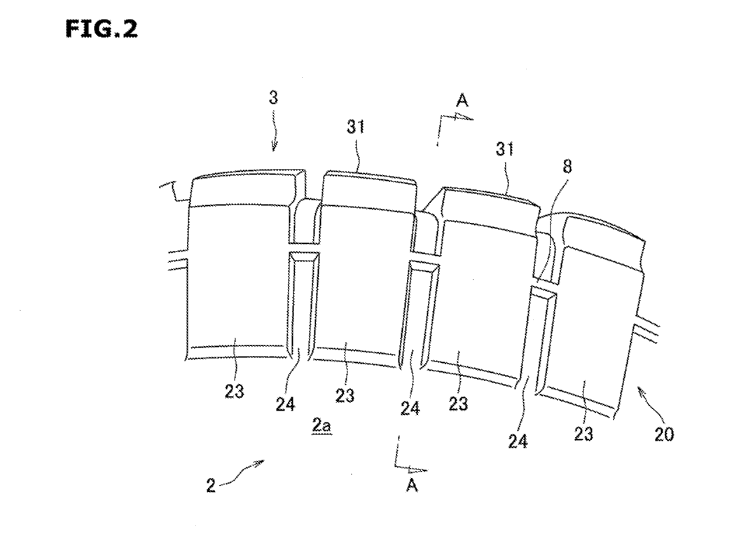

An embodiment of the present invention will be explained with reference to the drawings. FIG. 1 is a tire meridian cross sectional view schematically showing an example of a pneumatic tire according to the present invention, and corresponds to a cross sectional view along a line A-A in FIG. 2. FIG. 2 is a side elevational view showing a part of a buttress region as seen from a tire width direction, and corresponds to a view as seen from an arrow B in FIG. 1.

A pneumatic tire T is an off-road pneumatic radial tire aiming at traveling on a punishing road which includes a muddy terrain and a rocky stretch. The tire T is provided with a pair of bead portions 1, side wall portions 2 which extend outward in a tire diametrical direction from each of the bead portions 1, and a tread portion 3 which is connected to an outside end in the tire diametrical direction of each of the side wall portions 2. The bead portion 1 is provided with an annular bead core la formed by coating a convergence body of steel wire with rubber, and a bead filler 1b which is arranged in an outer side in the tire diametrical direction of the bead core 1a.

The pneumatic tire T is further provided with a carcass 4 which is arranged between a pair of bead portions 1, and a belt 5 which is arranged in an outer peripheral side of the carcass 4 in the tread portion 3. The carcass 4 is formed into a toroidal shape as a whole, and is wound up its end portion in such a manner as to pinch the bead core 1a and the bead filler 1b. The belt 5 includes two belt plies which are layered inward and outward, and is provided with a tread rubber 6 in its outer peripheral side. A tread pattern is formed on a surface of the tread rubber 6.

An inner liner 7 is provided in an inner peripheral side of the carcass 4 for keeping pneumatic pressure. The inner liner 7 faces to an internal space of the tire T in which air is filled. In the side wall portion 2, the inner liner 7 is directly attached to an inner peripheral side of the carcass 4, and any other member is not interposed between them.

As shown in FIG. 2, an annular projections group 20 is formed on an outer surface 2a of the buttress region in each of the side wall portions 2, the annular projections group 20 being obtained by arranging a plurality of projections 23 extending in a tire diametrical direction side by side in a tire circumferential direction. In the portion which is not illustrated, the projections 23 are arranged side by side in the tire circumferential direction in the same manner, and the arrangement bodies construct the annular projections group 20. In a scene traveling on the punishing road such as the muddy terrain, the traction is generated by the shear resistance of the projections 23 extending in the tire diametrical direction, and it is possible to improve the punishing road traveling property.

The buttress region is a region in an outer side in a tire diametrical direction of the side wall portion 2, and more particularly a region in the outer side in the tire diametrical direction from a tire maximum width position 9, and corresponds to a region which does not ground contact at the normal traveling time on a flat paved road. Since the tire sinks down on a soft road such as the muddy terrain and the sand pip due to a weight of a vehicle, the buttress region ground contacts in a pseudo manner. The tire maximum width position 9 is a position where a profile line of the tier T is away from a tire equator TC at the maximum in the tire width direction. The profile line is a contour line which forms an outer surface of the side wall portion 2 except the projections, and normally has a meridian cross sectional shape which is defined by smoothly connecting a plurality of circular arcs.

In the present embodiment, a tire diametrical outside end (hereinafter, refer to as an outside end) of the projection 23 is connected to a side surface of a land portion 31 in the tread portion 3. A tire diametrical inside end (hereinafter, refer to as an inside end) of the projection 23 is arranged in an outer side in the tire diametrical direction than the tire maximum width position 9. The projection 23 is formed into a rectangular shape in a side view, however, is not limited to this, and may be formed into the other polygonal shapes than the rectangular shape or the other shapes. Further, in the projection 23, a length in the tire diametrical direction is larger than a width in the tire circumferential direction in a side view. A width of a gap between the projections 23 is set to be smaller than a width of the projection 23 which is adjacent to the gap 24.

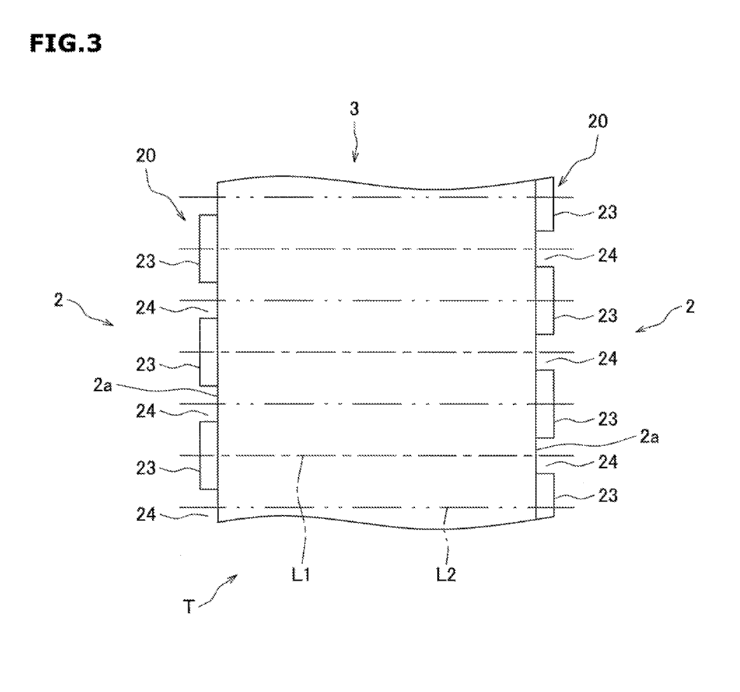

As shown in FIG. 3, the annular projections groups 20 in both sides are arranged to be shifted in the tire circumferential direction in such a manner that a center position in the width of the projection 23 in one side (for example, in a left side) is faced to the gap 24 between the projections 23 in the other side (for example, in a right side), and a center position in the width of the projection 23 in the other side is faced to the gap between the projections 23 in the one side. In the drawing, the center position in the width of the projection 23 shown in the left side is indicated by a single-dot chain line L1, the center position in the width of the projection 23 shown in the right side is indicated by a two-dot chain line L2, and each of the center positions passes through the gap 24 between the projections 23 in the opposite side.

In the tire T, the annular projections groups 20 in both sides are arranged to be shifted their positions in the tire circumferential direction as mentioned above. As a result, the unbalance caused by the rubber volume is canceled, and the inner periphery is uniformized, so that it is possible to suppress the deterioration of the uniformity. Further, since the annular projections groups 20 in both sides are shifted from each other as mentioned above, the right and left projections 23 enter into the soft road such as the muddy terrain alternately. Therefore, it is possible to effectively generate the traction.

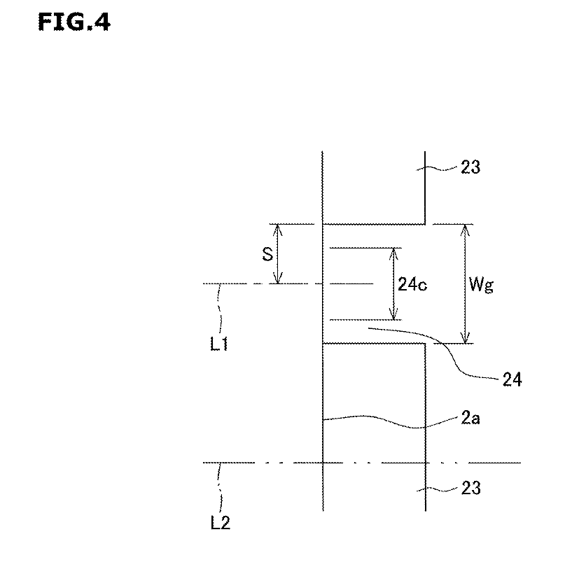

As shown in FIG. 4, the center position in the width of the projection 23 is preferably faced to a center area 24c of the gap 24 between the projections 23 in an opposite side thereof. The center area 24c of the gap 24 is a region in a range of 60% of a width Wg of the gap 24 around the center position in the width of the gap 24, and more preferably a region in a range of 50% of the width Wg. Although not being drawn in FIG. 4, the same applies to the center position in the width of the projection 23 shown by the two-dot chain line L2.

In the present embodiment, a circumferential rib 8 extending in the tire circumferential direction and connecting the projections each other is formed on the outer surface 2a in the buttress region of the side wall portion 2. The rigidity of each of the projections 21 and 22 is enhanced by the connection with the circumferential rib 8, and it is possible to improve the traction caused by the shear resistance of the projection. Since the configuration of the circumferential rib 8 is the same as an embodiment mentioned later, a detailed description thereof will be omitted.

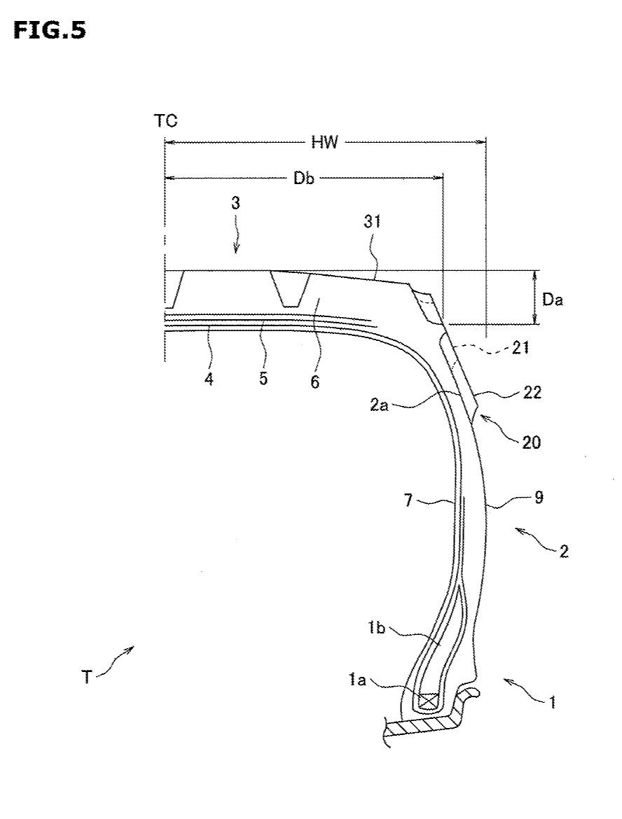

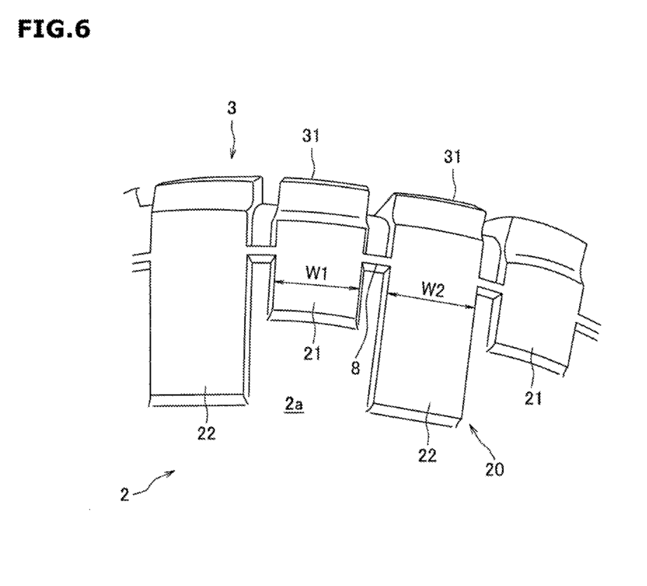

Since an embodiment shown in FIGS. 5 to 7 has the same configuration as that of the embodiment mentioned above except the configuration which is described below, a description will be mainly given of a different point while omitting common points. The same reference numerals are attached to the same positions as the positions which are described in the embodiment mentioned above, and an overlapping description will be omitted.

In FIGS. 5 to 7, the annular projections group 20 is constructed by plural kinds (two kinds in the present embodiment) of projections 21 and 22 having different volumes. As a result, there can be obtained an effect of improving the catching action on the rocky stretch, and enhancing the design property by applying the stereoscopic effect to the buttress region. In the same manner as the embodiment mentioned above, the annular projections groups 20 in both sides are arranged to be shifted their positions in the tire circumferential direction in such a manner that the center position in the width of the projection in one side is faced to the gap between the projections in the other side, and the center position in the width of the projection in the other side is faced to the gap between the projections in the one side.

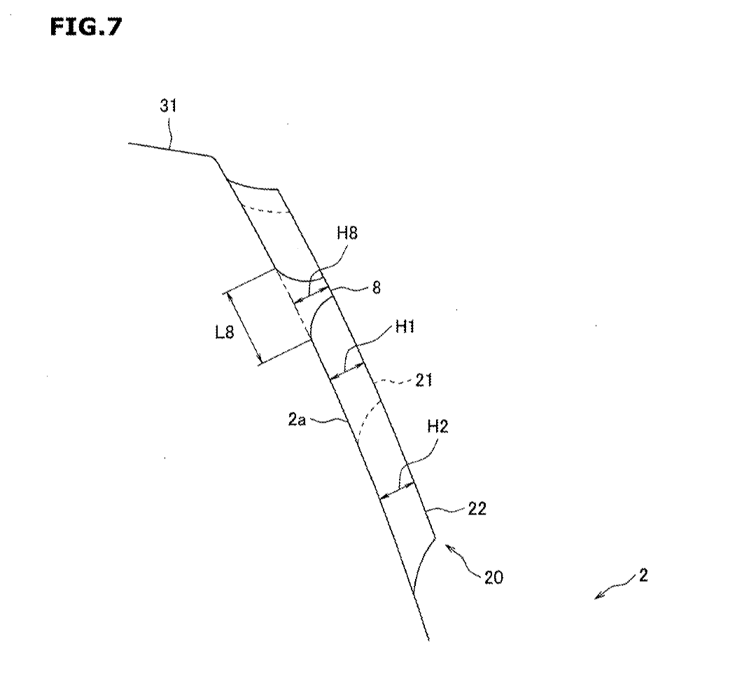

In the present embodiment, there is shown an example in which two kinds of projections 21 and 22 having different volumes are alternately arranged. A width of a gap existing between the adjacent projections 21 and 22 is set to be smaller than a width of each of the projections 21 and 22 in both sides of the gap. The projection 21 and the projection 22 are alternately arranged in the same manner in the other portions which are not shown in FIG. 7, and an arrangement body thereof constructs an annular projections group 20. The projections constructing the annular projections group are not limited to two kinds, but the annular projections group may be formed by arranging three or more kinds (for example, three to ten kinds) of projections having different volumes.

Each of the projections 21 and 22 constructing the annular projections group 20 bulges from the outer surface 2a of the side wall portion 2 along a profile line of the tire T, and the volume of each of the projections 21 and 22 is determined on the basis of the portion bulging from the outer surface 2a. In the present embodiment, there is shown an example in which a circumferential rib 8 is formed in the buttress region, however, a portion of the circumferential rib 8 protruding out of a side surface of each of the projections 21 and 22 is not considered as the volume of the projections 21 and 22 in this case.

The volume of the projection can be determined, for example, by measuring concavities and convexities of the side wall portion with using a three-dimensional measuring tool and preparing a three-dimensional modeling while combining actually measured dimensional values as occasion demands. Alternatively, it can be determined by molding the side wall portion with using gypsum and utilizing the gypsum mold.

The projections 21 and 22 are differentiated from each other in their lengths in the tire diametrical direction, however, widths W1 and W2 in the tire circumferential direction are set to be approximately the same dimension, and heights H1 and H2 from the outer surface 2a are set to be approximately the same dimension. In order to enhance the effects of improving the catching action on the rocky stretch and improving the design property by applying the stereoscopic effect to the buttress region, these projections are preferably differentiated from each other in at least one of the length and the height.

As shown in FIG. 7, the heights H1 and H2 of the projections 21 and 22 are approximately fixed from an edge of the outside end to an edge of the inside end. The greater the heights H1 and H2 are, the more the punishing road traveling property can be improved by enhancing the traction caused by the shear resistance, and the more the external damage resistance can be improved by keeping the external damage factor such as an angular portion of a rock face away from the outer surface 2a. In the light of the above, each of the height H1 and the height H2 is preferably equal to or more than 5 mm, and more preferably equal to or more than 3 mm.

In the present embodiment, a circumferential rib 8 extending in the tire circumferential direction and connecting the projections each other is formed on the outer surface 2a in the buttress region of the side wall portion 2. The rigidity of each of the projections 21 and 22 is enhanced by the connection with the circumferential rib 8, and it is possible to improve the traction caused by the shear resistance of the projection. The circumferential rib 8 extends on an annular line which is along the tire circumferential direction. Each of the projections 21 and 22 extends to an inner side and an outer side in the tire diametrical direction from the circumferential rib 8, however, preferably extends at least to the inner side in the tire diametrical direction from the circumferential rib 8.

A cross sectional shape of the circumferential rib 8 is formed into a flat chevron shape in its upper end surface, and more particularly formed into a composite volcano shape that an inclined surface is gently curved and narrowed. In the light of enhancement in the rigidity of the projection, a height H8 of the circumferential rib 8 is preferably equal to or more than 5 mm, more preferably goes beyond 5 mm, and is further preferably equal to or more than 8 mm. In the present embodiment, the height of the circumferential rib 8 is substantially the same as the height of each of the projections 21 and 22, however, is not limited to this. Further, in the light of enhancement in the rigidity of the projection, a contact length L8 of the circumferential rib 8 in relation to the outer surface 2a is preferably equal to or more than the height H8.

The circumferential rib 8 is set, for example, to a position where a distance Da shown in FIG. 1 is in a range between 20 and 40 mm. The distance Da is determined as a distance in the tire diametrical direction from a position of the outermost diameter of the tire T to a tire diametrical outside edge of an upper end surface of the circumferential rib 8. Further, the circumferential rib 8 is set, for example, to a position where a distance Db shown in FIG. 1 is 75% or more of a tire cross section half width HW. The distance Db is determined as a distance in the tire width direction from the tire equator TC to the tire diametrical outside edge of the upper end surface of the circumferential rib 8, and the tire cross section half width HW is determined as a distance in the tire width direction from the tire equator TC to the tire maximum width position 9.

Each of the dimensional values mentioned above is measured in a no-load normal state in which the tire is installed to a normal rim and a normal internal pressure is filled in the tire. The normal rim is a rim which is defined by a standard for every tire in a standard system including the standard on which the tire is based, for example, a standard rim in JATMA, “Design Rim” in TRA or “Measuring Rim” in ETRTO. Further, the normal internal pressure is a pneumatic pressure which is defined by each of the standards for every tire in the standard system including the standard on which the tire is based, and is a maximum pneumatic pressure in JATMA, the maximum value described in Table “TIRE LOAD LIMITS AT VARIOUS COLD INFLATION PRESSURES” in TRA, or “INFLATION PRESSURE” in ETRTO.

Since the pneumatic tire according to the present invention has the annular projections group which can improve the punishing road traveling property, the pneumatic tire can be preferably employed in a light truck such as a pickup truck for an off-road racing aiming at traveling on the punishing road Including the muddy terrain and the rocky stretch, and for a vehicle dispatched to a disaster site.

The pneumatic tire according to the present invention can be configured in the same manner as the regular pneumatic tire except the formation of the annular projections group as mentioned above in the buttress region of the side wall portion. Therefore, the conventionally known materials, shapes, structures and manufacturing methods can be employed in the present invention.

The present invention is not limited to the embodiment mentioned above, but can be improved and modified variously within the scope of the present invention.

### EXAMPLES

In order to specifically show the configuration and the

effect of the present invention, an evaluation about uniformity of the tire was carried out and a description will be given of the evaluation.

The uniformity of the tire was evaluated by measuring a radial force variation (RFV) on the basis of a test method defined in JISD4233. Specifically, the tire was pressed to a rotary drum so that a predetermined load is applied, and an amount of fluctuation of a reaction force in a radial direction was measured, the reaction force being generated when the tire is rotated while keeping a distance between both the shafts constant. The evaluation was made by an index number on the assumption that a result of Working Example 1 was set to 100. The smaller the numerical value is, the smaller the amount of fluctuation is, that is, an excellent uniformity is exhibited.

A Comparative Example was set to a configuration in which the annular projections groups in both sides are aligned their phases so that the center position in the width of the projection coincides with the center position in the width of the projection in the opposite side, in the pneumatic tire described in FIG. 5. Further, Working Examples 1 and 2 were set to the configurations in which the annular projections groups in both sides are shifted their phases so that the center position in

the width of the projection faces to the gap between the projections in the opposite side, in the pneumatic tire described in FIG. 5. In Table 1, a shift ratio is a ratio S/Wg of a shift amounts (refer to FIG. 4) in the tire circumferential direction from the center position in the width of the projection to the projection in the opposite side thereof in relation to the width Wg of the gap.

TABLE 1

| | Comparative | | |
|---|---|---|---|
| | Example | Example 1 | Example 2 |
| Shift ratio [S/Wg] | — | 50% | 20% |
| RFV | 110 | 100 | 105 |

As shown in Table 1, the RFV corresponding to the uniformity of the tire is improved in Working Examples 1 and 2, in comparison with the Comparative Example, and it is possible to confirm the effect obtained by the configuration in which the annular projections groups in both sides are arranged to be shifted their phases from each other.

What is claimed is:

1. A pneumatic tire comprising:
a pair of bead portions;
side wall portions which extend outward in a tire diametrical direction from each of the bead portions; and
a tread portion which is connected to an outside end in the tire diametrical direction of each of the side wall portions,
wherein an annular projections group in which a plurality of projections extending in the tire diametrical direction are arranged in a tire circumferential direction, is formed on an outer surface of a buttress region of the side wall portion, and
wherein the annular projections groups at both sides are arranged to be shifted their positions in the tire circumferential direction in such a manner that a center position in the width of a projection in one side is faced to a gap between projections in the other side, and a center position in the width of a projection in the other side is faced to a gap between projections in the one side.

2. The pneumatic tire according to claim 1, wherein the center position in the width of the projection faces to a center area of the gap be tween the projections in an opposite side thereof, and
wherein the center area of the gap is a region in a range of 60% of the width of the gap around the center position in the width of the gap.

3. The pneumatic tire according to claim 1, wherein the annular projections group is constructed by plural kinds of projections having different volumes.

4. The pneumatic tire according to claim 1, wherein a circumferential rib extending in the tire circumferential direction and connecting the projections each other is formed on the outer surface of the buttress region in the side wall portion.

5. The pneumatic tire according to claim 1, wherein a tire diametrical outside end of the projection is connected to a side surface in a land portion of the tread portion.

6. The pneumatic tire according to claim 1, wherein a tire diametrical inside end of the projection is arranged closer to an outer side in the tire diametrical direction than a tire maximum width position.

7. The pneumatic tire according to claim 1, wherein the projection is greater in its length in the tire diametrical direction than in its width in the tire circumferential direction in a side view.

8. The pneumatic tire according to claim 1, wherein the width of the gap between the projections is set to be smaller than a width of the projection which is adjacent to the gap.
